(19) United States
(12) Patent Application Publication
(10) Pub. No.: US 2006/0202921 A1
(43) Pub. Date: Sep. 14, 2006

(54) Driving device of self-luminous panel and driving method of the same

(75) Inventors: Naoto Suzuki, Yonezawa-shi (JP); Hiroyuki Sato, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Yamagata (JP)

(21) Appl. No.: 11/369,842

(22) Filed: Mar. 8, 2006

(30) Foreign Application Priority Data
Mar. 11, 2005 (JP) 2005-068847

(51) Int. Cl. G09G 3/30

(52) U.S. Cl. 345/76

(57) ABSTRACT

A device for driving a self-luminous panel has self-luminous elements arranged at intersecting positions of a plurality of data lines and a plurality of scanning lines and selectively drives the self-luminous elements for luminescence by data line driving means and scanning line scanning means and includes luminescence controlling means for controlling the operation of the data line driving means and the scanning line scanning means. Then, the luminescence controlling means sets a lighting scanning period, during which the self-luminous elements E have forward-biased voltages applied and hence light and luminescence, and a non-lighting scanning period, during which all of the self-luminous elements have reverse-biased voltages applied and hence do not light and luminescence, in one frame period during which the plurality of scanning lines are sequentially scanned by the scanning line scanning means and sets a length of the non-lighting scanning period shorter than a length of one scanning period during which one scanning line is scanned.

### BACKGROUND OF THE INVENTION

1. Field of the Invention

The present invention relates to a driving device of a self-luminous panel using self-luminous elements such as organic EL (electroluminescence) and a driving method of the same.

2. Description of the Related Art

Developments are being widely made in displays and the like using a luminescent panel in which luminescent elements are arranged in the shape of a matrix. An organic EL (luminescence) element using an organic material for a luminescent layer receives attention as a luminescent element used for such a luminescent panel.

The above-mentioned organic EL element can be electrically expressed by an equivalent circuit as shown in FIG. 1. That is, the organic EL element can be replaced by a construction including a luminescent element E formed of a diode component and a parasitic capacitance component Cp combined in parallel with this luminescent element and hence the organic EL element is thought to be a capacitive luminescent element.

It can be thought that: when this organic EL element has a luminescence controlling voltage applied thereto, first, electric charges corresponding to the electric capacitance of the element flow as a displacement current into an electrode and are stored; and then, when voltage exceeds a specified voltage (luminescence threshold voltage=Vth) specific to the element, current starts to flow from the electrode (anode side of the diode component E) to an organic layer constructing a luminescent layer and the element luminesces at intensity proportional to this current.

FIG. 2 shows luminescent static characteristics of this organic element. According to this characteristics, as shown in FIG. 2A, the organic EL element luminesces at luminance (L) nearly proportional to a driving current (I) and when a driving voltage (V) is larger than a luminescent threshold voltage (Vth), as shown in FIG. 2B, current (I) rapidly flows and the organic EL element luminesces. In other words, when a driving voltage is smaller than the luminescent threshold voltage (Vth), current hardly flows through the EL element and hence the EL element does not luminesce. Therefore, the luminance characteristics of the EL element, as shown by a solid line in FIG. 2C, has characteristics in which in a luminescent region where a driving voltage (V) is larger than the above-mentioned threshold voltage (Vth), as the driving voltage (V) applied to the EL element becomes larger, its luminescent luminance (L) becomes larger.

A passive driving type luminescent panel having organic EL elements arranged in the shape of a matrix has been already brought into partial practical use as a luminescent panel using organic EL elements. FIG. 3 shows an example of a passive driving type luminescent panel and a driving device thereof. A driving method of organic elements in this passive driving type system includes two methods of a method for scanning cathode lines and for driving anode lines and a method for scanning anode lines and driving cathode lines, and the example shown in FIG. 3 shows the embodiment of the former, that is, the method for scanning cathode lines and for driving anode lines.

That is, anode lines A1 to An as n data lines are arranged in a longitudinal direction and cathode lines K1 to Km as m scanning lines are arranged in a lateral direction and organic EL elements E as luminescent elements shown by the SYmbol marks of diodes are arranged at the intersecting portions (n×m portions in total) of the anode lines and the cathode lines to thereby construct a luminescent panel 1.

Then, in correspondence to each of the intersecting positions of the anode lines A1 to An along a vertical direction and the cathodes lines K1 to Km along a horizontal direction, each of the respective EL elements E11 to Enm constructing pixels has its one end (anode terminal in an equivalent diode of the EL element) connected to each of the anode lines and its other end (cathode terminal in the equivalent diode of the EL element) connected to each of the cathode lines. Furthermore, the respective anode lines A1 to An are connected to and driven by an anode line driving circuit 2 and the respective cathode lines K1 to Km are connected to and driven by a cathode line scanning circuit 3.

The above-mentioned anode line driving circuit 2 is provided with constant current sources I1 to In, which are driven by a supply power source VH to produce constant driving currents, and driving switches SX1 to SXn, and is constructed in such a way as to supply the driving currents from the constant current sources I1 to In to the respective anode lines A1 to An.

That is, when the driving switches SX1 to SXn select the constant current sources I1 to In, currents from the constant current sources I1 to In are supplied to the individual EL elements E11 to Enm arranged in correspondence to the cathode lines. Then, when the driving switches SX1 to SXn do not supply currents from the constant current sources I1 to In to the individual EL elements, the driving switches SX1 to SXn can be connected to the ground side as a reference potential point.

Meanwhile, the above-mentioned cathode line scanning circuit 3 is provided with scanning switches SY1 to SYm in correspondence to the respective cathode lines K1 to Km, and the scanning switches SY1 to SYm function so as to connect either of, for example, the reverse-biased voltage VM obtained by dividing the above-mentioned supply power source VH and the ground potential as a scanning reference potential point to the cathode lines corresponding to them.

With this, by connecting the constant current sources I1 to In to the desired anode lines A1 to An wile setting the cathode lines at the scanning reference potential point (ground potential) at specified periods, the respective EL elements are selectively made to luminesce. In this regard, in place of the constant current sources, constant voltage circuits can be used as driving sources. However, the current-luminance characteristics of the EL element is stable for temperature change, whereas the voltage-luminance characteristics of the EL element is not stable for temperature change. For this reason, the constant current sources are commonly used as the driving power sources as shown in FIG. 3.

Moreover, although not shown in FIG. 3, the anode line driving circuit 2 and the cathode line scanning circuit 3 are supplied with an instruction from a luminescence controlling circuit and function so as to make pixels, which correspond to luminescence data supplied to the luminescence controlling circuit, luminesce according to the luminescence data. In this case, the cathode line scanning circuit 3 performs the control of sequentially switching the scanning switches SY1 to SYm according to the instruction supplied from the luminescence controlling circuit to select any one of cathode lines corresponding to the horizontal scanning period of the luminescence data, thereby setting the selected scanning line at the ground potential as a scanning reference potential point and applying a reverse-biased voltage VM to the other non-scanned scanning lines. Here, the state shown in FIG. 3 shows a state where the second cathode line K2 is scanned and where the other cathode lines have the reverse-biased voltage VM applied.

The above-mentioned reverse-biased voltage VM functions in such a way as to charge the parasitic capacitance of the driven EL element, which is connected to the intersection of the selectively scanned cathode line, and to prevent the EL elements, which are connected to intersections of the driven anode line and the cathode lines that are not selectively scanned, from causing cross talk luminescence by leak currents. This reverse-biased voltage VM is commonly set at a value nearly equal to the forward voltage Vf of the EL element in a luminescent state. Then, because the scanning switches SY1 to SYm are sequentially switched to the ground potential for each horizontal scanning period, the cathode lines set at the ground potential set the EL elements connected to the cathode lines in a state where the EL elements can luminescence.

Meanwhile, the anode line driving circuit 2 is supplied with a drive controlling signal for controlling at which timing how much of time any one of EL elements connected to the anode lines is made to luminesce based on pixel information shown by luminescence data by the above-mentioned luminescence controlling circuit. The anode line driving circuit 2 functions so as to switch some of the driving switches SX1 to SXn to the constant current power sources I1 to In according to this drive controlling signal to supply the EL elements corresponding to the luminescence data via the anode lines A1 to An with driving currents.

In this manner, the EL elements supplied with the driving currents are controlled to luminesce according to the above-mentioned luminescence data. Here, the state shown in FIG. 3 is a state where the second cathode line K2 is scanned as described above and SX2 and SX3 of the driving switches SX1 to SXn are connected to the constant current source side, the encircled EL elements E22 and E32 are controlled to luminesce.

By the way, in the above-mentioned passive type driving system, in general, as shown by a timing chart in FIG. 4, one frame period is constructed of a reset period, a pre-charging period for charging the parasitic capacitance of the EL element, a lighting scanning period including a plurality of scanning periods (SP) during which the respective cathode lines are scanned for luminescence, and a non lighting scanning period (NSP) during which all of the cathode lines are not scanned for luminescence, in this order. Then, in the respective periods in one frame period, voltages shown in Table 1 are applied to the data lines, the selected scanning lines (cathode lines), and the non-selected scanning lines.

TABLE 1

| | | | Lighting | |
|---|---|---|---|---|
| | | Pre-charging | scanning | Non lighting |
| | Reset period | period | period | scanning period |
| Data line | Vm or GND | Vr | Vf | GND |
| Selected | — | GND | GND | — |
| scanning line | | | | |
| Non-selected | Vm or GND | Vm | Vm | Vm |
| scanning line | | | | |

Vm: reverse-biased voltage,
Vr: pre-charging voltage,
Vf: forward voltage (constant current)

In the lighting scanning period shown in Table 1, as described above, the reverse-biased voltage Vm is applied to the cathode lines that are not selected and scanned (non-selected scanning lines) and also in the non-lighting scanning period, the reverse-biased voltage is applied to all EL elements at the same time. That is, this is because it is known from experience that the luminescing life of the EL element can be elongated by applying the reverse-biased voltage, which does not contribute to a luminescing action, to the EL element and that as the number of applications of reverse-biased voltage to the EL element becomes larger, there is produced the self-repair effect of elongating the luminescing life. Then, the effect of elongating the life of the EL element by applying the reverse-biased voltage is described also in Japanese Unexamined Patent Publication No. 11-8064 (paragraphs 0003 to 0005, FIG. 2).

By the way, as for the length of a non-lighting scanning period (NSP) during which the reverse-biased voltage is applied to all of the EL elements, because the control of applying the reverse-biased voltage to the non-selected scanning lines in the lighting scanning period is performed by a scanning period (SP), the non-lighting scanning period is conventionally set between the first scanning period to the N-th scanning period (N: positive integer) in consideration of ease in the control. In this case, when the number of scanning lines (cathode lines) is large, there is no problem. However, when the number of scanning lines are extremely small (for example, 6 or the like), there is a problem that because one frame period is short, the ratio of non-lighting scanning period (NSP) in one frame period becomes larger and hence luminescence efficiency is reduced by a large amount. Moreover, as described above, because the length of the non-lighting scanning period (NSP) is one scanning period (SP) at the minimum, there is a problem that when the number of scanning lines varies, luminescence efficiency also varies.

### SUMAMRY OF THE INVENTION

This invention has been made in view of the problem of a reduction in luminescence efficiency caused in a passive driving type luminescent panel. The object of the present invention is to provide a driving device of a self-luminous panel that has a non-lighting scanning period (NSP) for applying reverse-biased voltages to all self-luminous elements in one frame period and hence can prevent a large reduction in luminescence efficiency caused by setting the non-lighting scanning period (NSP) and can improve the effect of applying the reverse-biased voltages to the self-luminous elements, and a driving method of the same.

A driving device of a self-luminous panel in accordance with the present invention made to solve the above-mentioned problems, as described in a first aspect, is a driving device of a self-luminous panel of the type in which self-luminous elements are arranged at intersecting positions of a plurality of data lines and a plurality of scanning lines and are selectively driven for luminescence by data line driving means and scanning line scanning means, and includes luminescence controlling means for controlling an operation of the data line driving means and the scanning line scanning means, and is characterized in that the luminescence controlling means sets a lighting scanning period, during which the self-luminous elements have forward-biased voltages applied and hence light and luminescence, and a non-lighting scanning period, during which all of the self-luminous elements have reverse-biased voltages applied and hence do not light and luminescence, in one frame period during which the plurality of scanning lines are sequentially scanned by the scanning line scanning means and sets a length of the non-lighting scanning period shorter than a length of one scanning period during which one scanning line is scanned.

Moreover, a driving device of a self-luminous panel in accordance with the present invention, as described in a second aspect, is a driving device of a self-luminous panel of the type in which self-luminous elements are arranged at intersecting positions of a plurality of data lines and a plurality of scanning lines and are selectively driven for luminescence by data line driving means and scanning line scanning means, and includes luminescence controlling means for controlling an operation of the data line driving means and the scanning line scanning means, and is characterized in that the luminescence controlling means sets a lighting scanning period, during which the self-luminous elements have forward-biased voltages applied and hence light and luminescence, and a non-lighting scanning period, during which all of the self-luminous elements have reverse-biased voltages applied and hence do not light and luminescence, in one frame period during which the plurality of scanning lines are sequentially scanned by the scanning line scanning means and sets the non-lighting scanning period on a plurality of occasions in the one frame period.

Furthermore, a driving method of a self-luminous panel in accordance with the present invention made to solve the above-mentioned problems, as described in a seventh aspect, is a driving method of a self-luminous panel of the type in which self-luminous elements are arranged at intersecting positions of a plurality of data lines and a plurality of scanning lines and are selectively driven for luminescence by data line driving means and scanning line scanning means, and is characterized in that a lighting scanning period, during which the self-luminous elements have forward-biased voltages applied and hence light and luminescence, and a non-lighting scanning period, during which all of the self-luminous elements have reverse-biased voltages applied and hence do not light and luminescence, are set in one frame period during which the plurality of scanning lines are sequentially scanned by the scanning line scanning means, a length of the non-lighting scanning period being set shorter than a length of one scanning period during which one scanning line is scanned.

Still furthermore, a driving method of a self-luminous panel in accordance with the present invention, as described in an eighth aspect, is a driving method of a self-luminous panel of the type in which self-luminous elements are arranged at intersecting positions of a plurality of data lines and a plurality of scanning lines and are selectively driven for luminescence by data line driving means and scanning line scanning means, and is characterized in that a lighting scanning period, during which the self-luminous elements have forward-biased voltages applied and hence light and luminescence, and a non-lighting scanning period, during which all of the self-luminous elements have reverse-biased voltages applied and hence do not light and luminescence, are set in one frame period during which the plurality of scanning lines are sequentially scanned by the scanning line scanning means, the non-lighting scanning period being set on a plurality of occasions in the one frame period.

### BRIEF DESCRIPTION OF THE DRAWINGS

FIG. 1 is an equivalent circuit diagram showing the electric construction of an organic EL element;

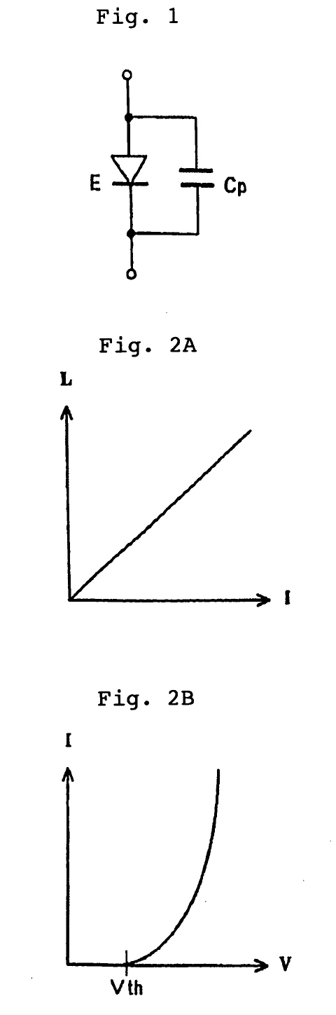

FIG. 2 is a characteristic diagram showing the electric static characteristics of an organic EL element;

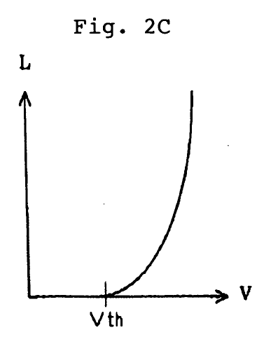

FIG. 3 is a connection diagram showing an example of a driving device of a conventional passive driving type luminescent panel;

FIG. 4 is a timing chart showing the construction of one frame period in the conventional passive driving type luminescent panel;

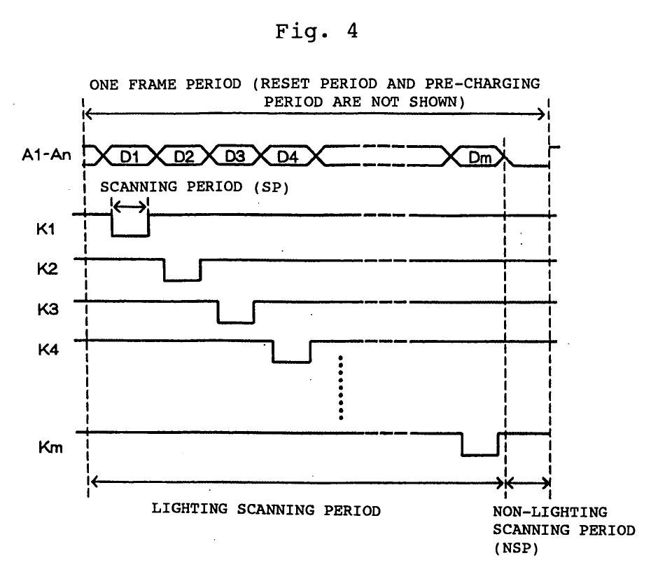

FIG. 5 is a block diagram showing a driving device of a passive driving type luminescent panel in accordance with a first embodiment of the present invention;

FIG. 6 is a chart showing one example of scanning timing in one frame period by the driving device in FIG. 5;

FIG. 7 is a block diagram showing a driving device of a passive driving type luminescent panel in accordance with the second embodiment of the present invention;

FIG. 8 is a chart showing one example of scanning timing in one frame period by the driving device in FIG. 7; and

FIG. 9 is a chart showing another example of scanning timing in one frame period by the driving device in FIG. 7.

### DETAILED DESCRIPTION OF THE PREFERRED EMBODIMENTS

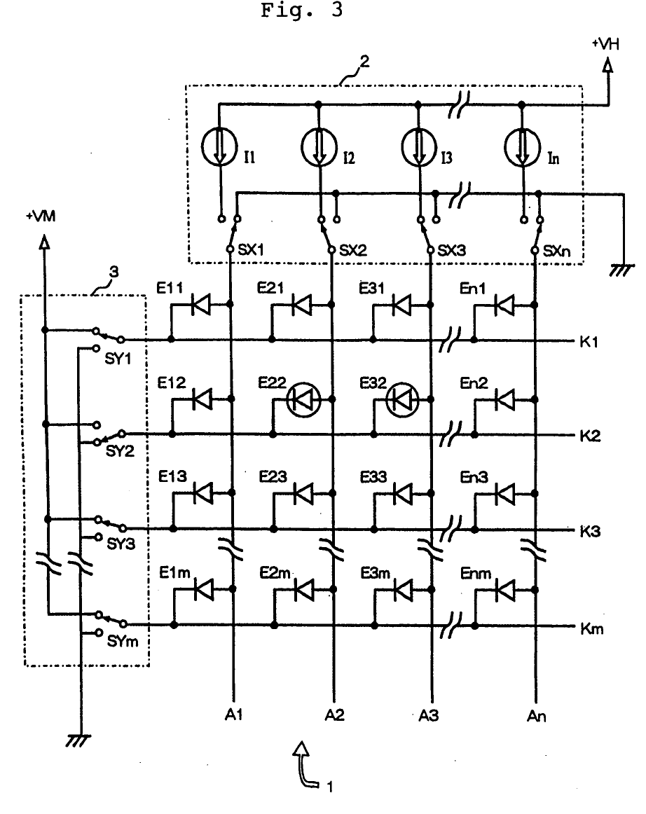

Hereinafter, a driving device of a self-luminous panel in accordance with this invention and a driving method of the same will be described on the basis of embodiments shown in the drawings. Here, in the following description, parts corresponding to the respective parts shown in FIG. 3 already described are denoted by the same reference SYmbols and hence the descriptions of their individual functions and operations will be omitted as deemed appropriate.

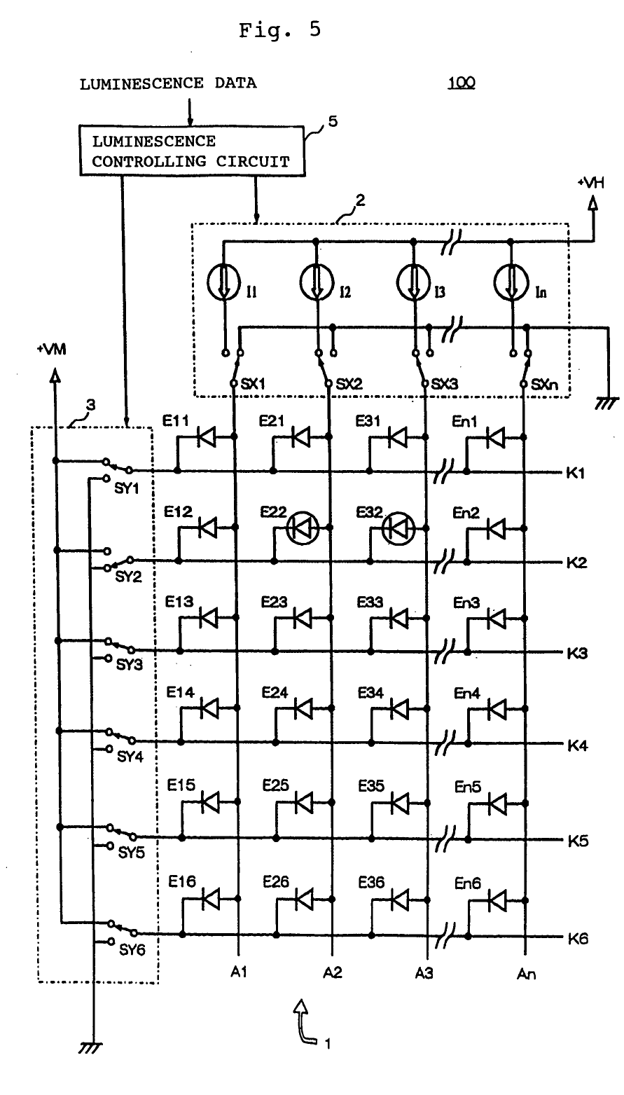

First, the first embodiment of a driving device of a self-luminous panel in accordance with the present invention and a driving method of the same will be described. FIG. 5 is a block diagram showing the first embodiment of a passive driving type luminescent panel 1 and its driving device 100. Here, this embodiment, just as with FIG. 3, is assumed to be constructed in such a way that anode lines are set as driving lines and that cathode lines are set as scanning lines.

Then, a circuit construction shown in FIG. 5 is constructed of six cathode lines K (K1 to K6) which become scanning lines in a passive driving type luminescent panel 1. That is, this circuit is constructed of a small number of scanning lines and hence this luminescent panel 1 is used more suitably as the printer light source of a printer or the like than as the display panel of image data. Then, FIG. 5 shows a luminescence controlling circuit 5 (luminescence controlling means), which is not shown in FIG. 3. The luminescence controlling circuit 5 controls the operation of an anode line driving circuit 2 (data line driving means) and cathode line scanning circuit 3 (scanning line scanning circuit).

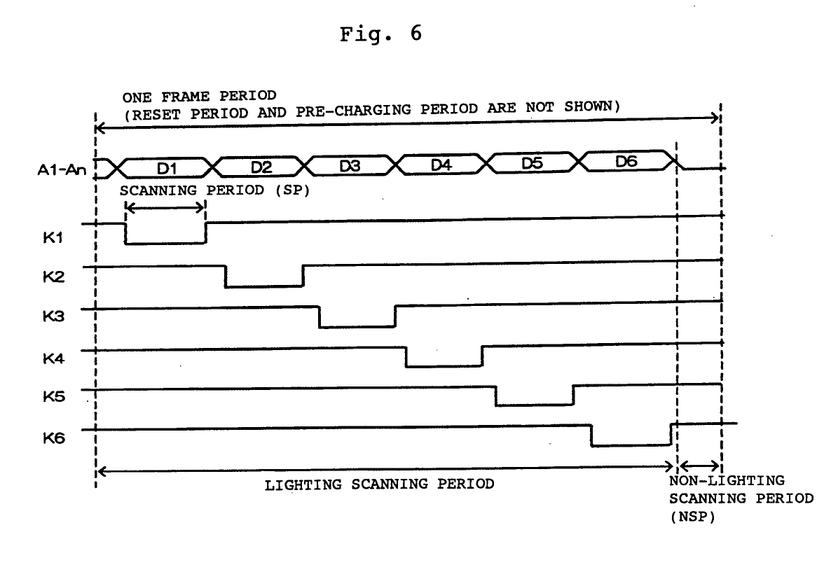

The operation of the driving device 100 of the passive driving type luminescent panel 1 constructed in this manner will be described on the basis of FIG. 6. FIG. 6 is a diagram showing scanning timing in one frame period and six scanning lines (K1 to K6). In one frame period, the luminescence controlling circuit 5 sequentially provides anode lines A1 to An with luminescence data D1 to D6 and sequentially controls the selection of scanning lines K1 to K6 in accordance with the timing.

Then, in the driving device 100 of the luminescent panel in this embodiment, as shown in FIG. 6, a non-lighting scanning period (NSP) that is shorter than one scanning period (SP) is set after finishing the scanning of all of 6 scanning lines. Then, in this non-lighting scanning period (NSP), all driving switches SX1 to SXn are switched to ground potential and all scanning switches SY1 to SY4 are switched to reverse-biased voltage VM. With this, reverse-biased voltage is applied to all of the EL elements at the same time.

As described above, according to the first embodiment in accordance with the present invention, when the number of scanning lines to be scanned is as small as several lines, the non-lighting scanning period (NSP) during which reverse-biased voltage is applied to all of the EL elements is set as a period shorter than one scanning period (SP). As a result, the ratio of the non-lighting scanning period (NSP) to one frame period can be smaller and hence luminescence efficiency can be improved as compared with a case where the non-lighting scanning period (NSP) is set by the scanning period (SP).

Successively, a second embodiment of a driving device of a self-luminous panel in accordance with the present invention and a driving method of the same will be described. Here, in the following description, parts corresponding to the respective parts shown in FIG. 3 and FIG. 5 in the first embodiment, which are already described, are denoted by the same reference SYmbols and hence the descriptions of their individual functions and operations will be omitted as deemed appropriate.

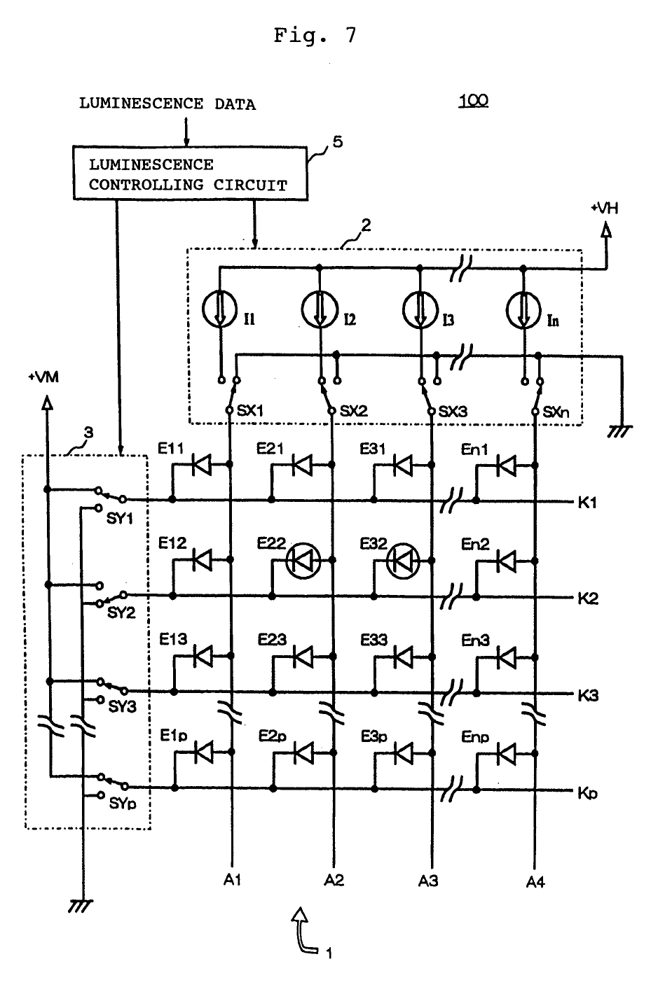

FIG. 7 is a block diagram showing the second embodiment of a passive driving type luminescent panel 1 and its driving device 100. Here, this embodiment, just as with FIG. 3 and FIG. 5, is assumed to be constructed in such a way that anode lines are driving lines and that cathode lines are scanning lines. Then, the circuit construction shown in FIG. 7 is assumed to be such that cathode lines K which become scanning lines in the passive driving type luminescent panel 1 includes p lines (K1 to Kp), which is different from FIG. 3.

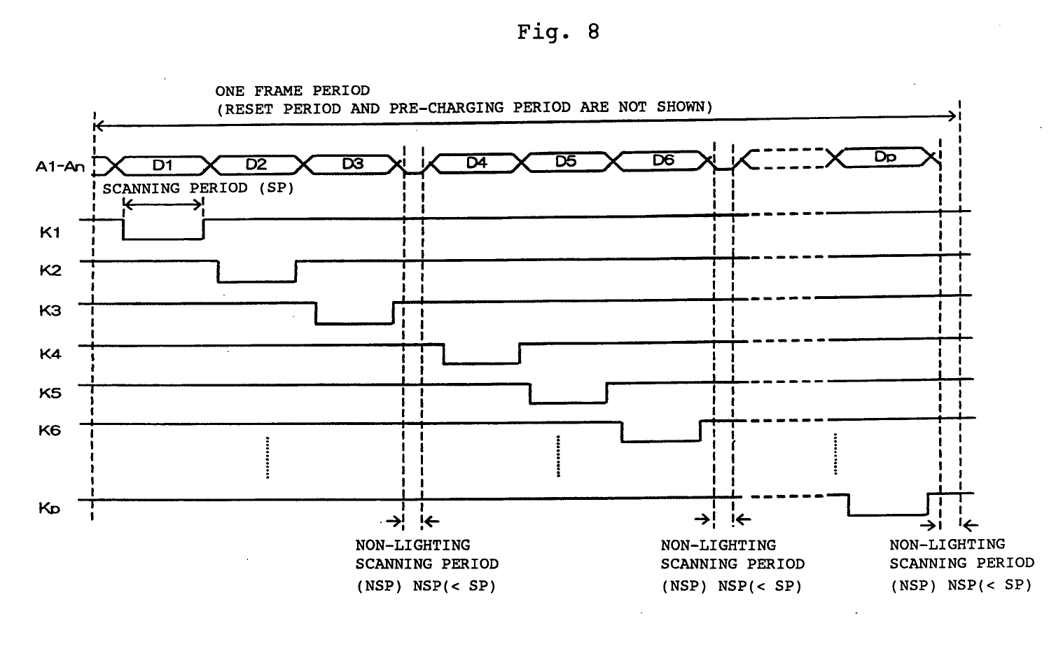

Successively, the control of driving the luminescence of the EL element by the driving device 100 in FIG. 7 will be described. FIG. 8 is a diagram showing scanning timing in one frame period and the scanning lines (K1 to Kp). In one frame period, the luminescence controlling circuit 5 sequentially provides anode lines A1 to An with luminescence data D1 to Dp and sequentially controls the selection of scanning lines K1 to Kp in accordance with the timing.

Then, in the driving device 100 of the luminescent panel 1 in this embodiment, as shown in FIG. 8, a non-lighting scanning period (NSP) is set for each scanning of three scanning lines and this non-lighting scanning period (NSP) is controlled to length that is different from one scanning period (SP) (for example, shorter length). That is, a plurality of non-lighting scanning periods (NSP) are set in one frame period. Then, at that time, the length of each non-lighting scanning period (NSP) is controlled in such a way that the ratio of the total of the non-lighting scanning periods (NSP) to one frame period becomes equal to the ratio in the conventional case where the number of scanning lines is n. In other words, the length of each non-lighting scanning period (NSP) is controlled in such a way that the ratio of the total of the non-lighting scanning periods (NSP) to one frame period becomes constant irrespective of the number of scanning lines.

Then, in the plurality of non-lighting scanning periods (NSP) in one frame period, all of the driving switches SX1 to SXn are switched to ground potential and all of the scanning switches SY1 to SY4 are switched to reverse-biased voltage VM. With this, reversed-biased voltage is applied to all of the EL elements at the same time.

As described above, according to the second embodiment in accordance with present invention, in the control of lighting the luminescent panel which is different in the number of scanning lines from a conventional luminescent panel, a plurality of non-lighting scanning periods (NSP) are set in one frame period and the length of each non-lighting scanning period is controlled. That is, the ratio of the total of the non-lighting scanning periods (NSP) to one frame is made equal to the ratio in the case of a conventional number of scanning lines. By the control like this, even if the number of scanning lines to be scanned varies, it is possible to keep the luminescent efficiency of the luminescent panel 1 constant. Then, reversed-biased voltage is applied to all of the EL elements in one frame on a plurality of occasions. Therefore, it is possible to further improve the self-repair efficiency of the EL element and hence to improve the effect of elongating the life of the luminescent panel.

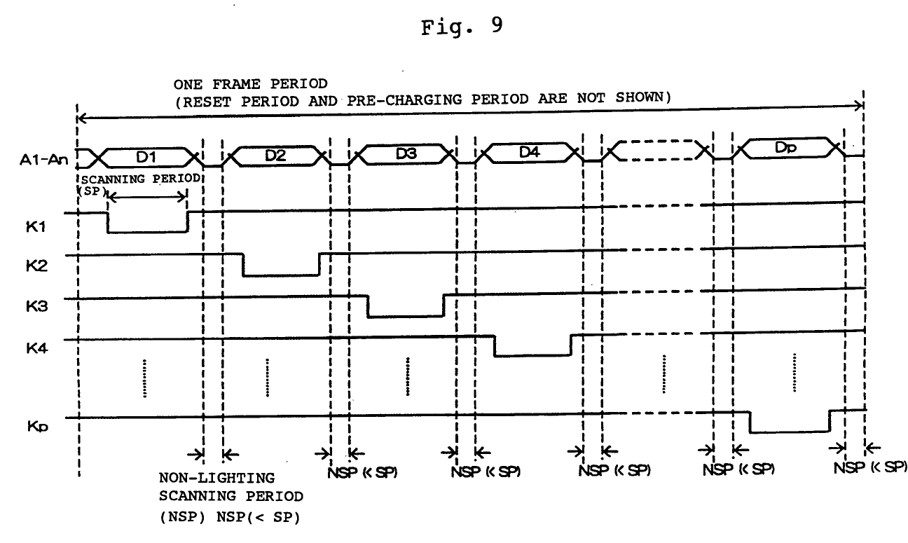

In this regard, in the control of the above-mentioned second embodiment, the non-lighting scanning periods (NSP) is set for each scanning of three scanning lines. However, the non-lighting scanning periods (NSP) is not necessarily set for each scanning of three scanning lines but may be set for each scanning of two or five scanning lines. For example, to further disperse the non-lighting scanning periods (NSP), as shown in FIG. 9, it is also recommendable to employ control such that one non-lighting scanning period (NSP) is set every one scanning period (SP) and that the reversed-biased voltage is applied to all of the EL elements in each non-lighting scanning period (NSP).

Then, in the case where the number of non-lighting scanning periods (NSP) included in one frame is varied, it is preferable that the length of the non-lighting scanning period (NSP) is controlled in such a way that the ratio of the total of non-lighting scanning periods (NSP) to one frame becomes constant irrespective of the number of non-lighting scanning periods (NSP) included in one frame period. With this control, it is possible to keep the luminescent efficiency of the luminescent panel 1 constant even if the number of non-lighting scanning periods (NSP) included in one frame period is varied.

In this regard, although examples of the case where the number of scanning lines is six have been described in the above-mentioned first and second embodiments, it is not intended to limit the number of scanning lines in the driving device of the luminescent panel in accordance with the present invention. Then, the above-mentioned embodiments are constructed in such a way that the anode lines are set as driving lining and that the cathode lines are set as scanning lines. However, the driving device and the driving method in accordance with the present invention may be constructed in such a way that the cathode lines are set as driving lines and that the anode lines are set as the scanning lines.

What is claimed is:

1. A driving device of a self-luminous panel of the type in which self-luminous elements are arranged at intersecting positions of a plurality of data lines and a plurality of scanning lines and are selectively driven for luminescence by data line driving means and scanning line scanning means comprising:
luminescence controlling means for controlling an operation of the data line driving means and the scanning line scanning means,
wherein the luminescence controlling means sets a lighting scanning period, during which the self-luminous elements have forward-biased voltages applied and hence light and luminescence, and a non-lighting scanning period, during which all of the self-luminous elements have reverse-biased voltages applied and hence do not light and luminescence, in one frame period during which the plurality of scanning lines are sequentially scanned by the scanning line scanning means and sets a length of the non-lighting scanning period shorter than a length of one scanning period during which one scanning line is scanned.

2. A driving device of a self-luminous panel of the type in which self-luminous elements are arranged at intersecting positions of a plurality of data lines and a plurality of scanning lines and are selectively driven for luminescence by data line driving means and scanning line scanning means comprising:
luminescence controlling means for controlling an operation of the data line driving means and the scanning line scanning means,
wherein the luminescence controlling means sets a lighting scanning period, during which the self-luminous elements have forward-biased voltages applied and hence light and luminescence, and a non-lighting scanning period, during which all of the self-luminous elements have reverse-biased voltages applied and hence do not light and luminescence, in one frame period during which the plurality of scanning lines are sequentially scanned by the scanning line scanning means and sets the non-lighting scanning period on a plurality of occasions in the one frame period.

3. The driving device of a self-luminous panel as claimed in claim 1 or 2, wherein the luminescence controlling means controls the data line driving means and the scanning line scanning means in such a way that a ratio of total time of the non-lighting scanning periods to the one frame period becomes constant irrespective of the number of the non-lighting scanning periods set in the one frame period.

4. The driving device of a self-luminous panel as claimed in claim 1 or 2, wherein the luminescence controlling means controls the data line driving means and the scanning line scanning means in such a way that a ratio of total time of the non-lighting scanning periods to the one frame period becomes constant irrespective of the number of scanning lines scanned in the one frame period.

5. The driving device of a self-luminous panel as claimed in claim 1 or 2, wherein the luminescence controlling means sets the non-lighting scanning periods on a plurality of occasions every one scanning period in the one frame period.

6. A driving method of a self-luminous panel of the type in which self-luminous elements are arranged at intersecting positions of a plurality of data lines and a plurality of scanning lines and are selectively driven for luminescence by data line driving means and scanning line scanning means, wherein a lighting scanning period, during which the self-luminous elements have forward-biased voltages applied and hence light and luminescence, and a non-lighting scanning period, during which all of the self-luminous elements have reverse-biased voltages applied and hence do not light and luminescence, are set in one frame period during which the plurality of scanning lines are sequentially scanned by the scanning line scanning means, a length of the non-lighting scanning period being set shorter than a length of one scanning period during which one scanning line is scanned.

7. A driving method of a self-luminous panel of the type in which self-luminous elements are arranged at intersecting positions of a plurality of data lines and a plurality of scanning lines and are selectively driven for luminescence by data line driving means and scanning line scanning means, wherein a lighting scanning period, during which the self-luminous elements have forward-biased voltages applied and hence light and luminescence, and a non-lighting scanning period, during which all of the self-luminous elements have reverse-biased voltages applied and hence do not light and luminescence, are set in one frame period during which the plurality of scanning lines are sequentially scanned by the scanning line scanning means, the non-lighting scanning period being set on a plurality of occasions in the one frame period.

8. The driving method of/a self-luminous panel as claimed in claim 6 or 7, wherein a ratio of total time of the non-lighting scanning periods to the one frame period becomes constant irrespective of the number of the non-lighting scanning periods set in the one frame period.

9. The driving method of a self-luminous panel as claimed in claim 6 or 7, wherein a ratio of total time of the non-lighting scanning periods to the one frame period becomes constant irrespective of the number of scanning lines scanned in the one frame period.

10. The driving method of a self-luminous panel as claimed in claim 6 or 7, wherein the non-lighting scanning period is set on a plurality of occasions every one scanning period in the one frame period.
